(19) United States
(12) Patent Application Publication
(10) Pub. No.: US 2011/0000178 A1
(43) Pub. Date: Jan. 6, 2011

(54) Multi-crop feeder and crop conditioner for stripper headers

(76) Inventor: Kirk Edward Giusti, Yuba City, CA (US)

Correspondence Address: Mr. Kirk E. Giusti, 826 E. Hillcrest Ave., Yuba City, CA, 95991, US

(21) Appl. No.: 12/803,427

(22) Filed: Jun. 28, 2010

Related U.S. Application Data
(60) Provisional application No. 61/270,172, filed on Jul. 6, 2009.

(51) Int. Cl. A01D 89/00

(52) U.S. Cl. 56/364

(57) ABSTRACT

The attachment of a feeder reel, also called a crop conditioner, to the front of a stripper header to accomplish the harvesting of crops with bent stems and stems on the ground that were unable to be harvested with only the stripper header. Attaching the feeder reel to a movable framework attached to the stripper header to allow for different positions is required to efficiently harvest different crops and different crop conditions. The feeder reel directs the crop stem into the stripper.

### BACKGROUND OF THE INVENTION

Feeder reels have been used on conventional grain headers for several decades. Conventional grain headers cut the stock of grain and pull the entire cutting, grain and stock into the receiving mechanism of the harvester. Feeder reels are used to guide the grain stocks into the cutters and the receiving mechanism. Grain harvesters with stripper headers are designed to function without the feeder reel and only remove the grain from the stock leaving the stock uncut.

The major problem with the stripper header design is that downed grain stocks are difficult if not impossible to harvest because a feeder reel is not used to stand up the stocks so that the grain can be removed. My invention is the addition of a feeder wheel in front of the stripper header to allow faster harvesting and harvesting of the downed grain stocks. The feeder wheel stands up the grain stocks and guides the stocks into the stripper for more efficient harvesting—removal of the grain from the stocks. The main problem was how to attach the reel and set the correct position for the reel in relation to the stripper header. Stripper headers have not been designed for the addition of a feeder reel. My invention has resolved the attachment design and downed grain can now be harvested with the stripper header by attaching the feeder reel.

### SUMMARY OF THE INVENTION

This invention is the attachment of a feeder reel—crop conditioner to a stripper header positioning the reel in front of the stripper header to allow the fingers on the reel to stand up and guide the grain stocks into the header. The reel is turned by the hydraulic system on the harvester or by any other method such as electric or fuel motor using gears, belts, chain drive or any other means. Basic principal is to be able to control the revolving speed and the position of the feeder reel in relation to the crop receiver in the front of the stripper header. The feeder reel allows the stripper header to function more efficiently with both standing grain stocks and bent over stocks including stocks bent over on the ground.

### BRIEF DESCRIPTION OF THE SEVERAL VIEWS OF THE INVENTION

FIG. 1 is a side view of the framework which holds the reel and is attached to the top of the stripper header. The rams which control the position of the reel to the stripper header are mounted to rear of the header.

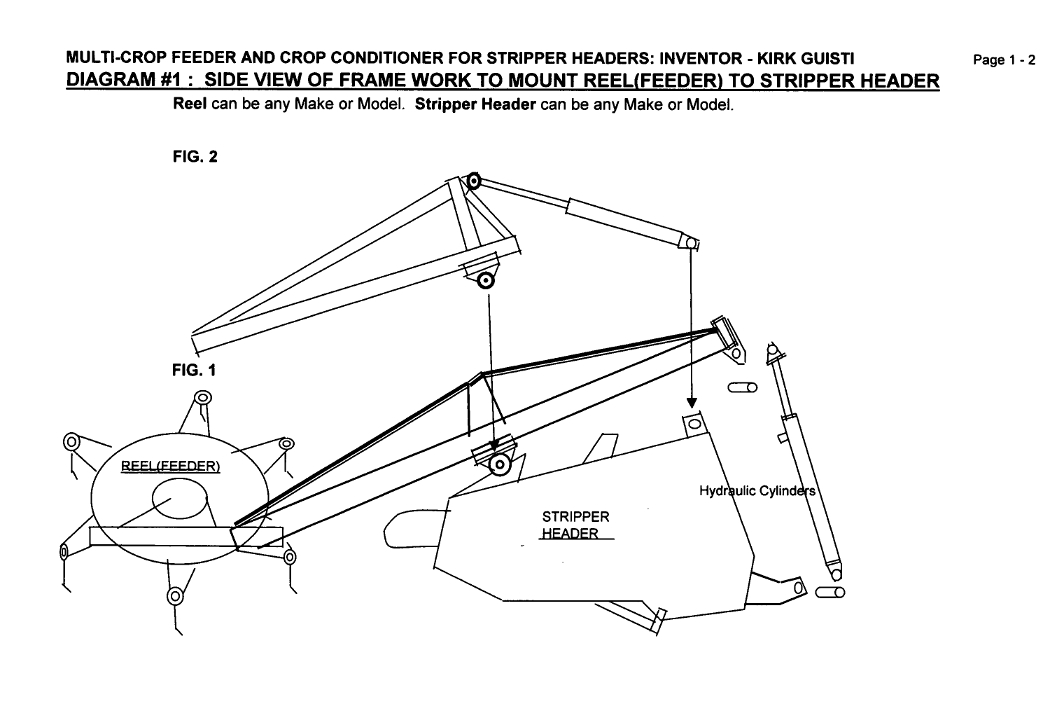

FIG. 2 is a side view of the framework to hold the reel with the rams mounted on top of the header.

FIG. 3 is a 45 degree frontal view of the frame with the feeder reel removed to show the various parts that may be used for attachment when mounting the rams to the rear of the header.

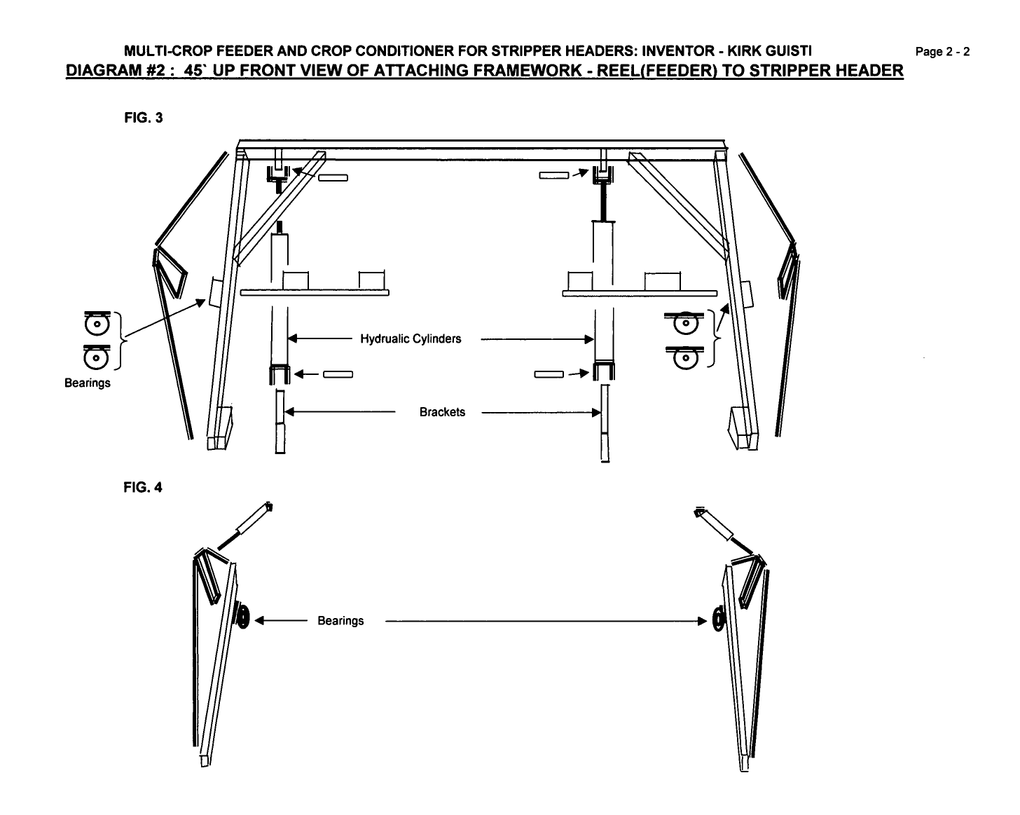

FIG. 4 is a 45 degree frontal view of the frame to mount the feeder reel with the rams mounted on top of the header.

### DETAILED DESCRIPTION OF THE INVENTION

This patent application is for improving the function of the stripper headers to harvest more crops and harvest crops more effectively. This application is for attaching an adjustable reel or similar device called a feeder or crop conditioner, to the stripper header to improve on the harvesting capabilities. This reel or similar device will be adjustable up and down as well as fore and aft and side to side. The front bonnet can be moved to accommodate a more efficient delivery of the crop to the rotating fingers of the reel thereby improving the delivery of the crop to the stripper header.

The main objective of this invention is to place a reel or similar device of any make, manufacture or model, home-made or commercial, in front of a stripper header, and attached to such for the purpose of increasing the amount of grain or other crop that can be harvested by the stripper header. The reel or similar device will be attached in the manner that allows for adjustment of it's position in relation to the stripper header. The designed adjustments will be fore or aft, up or down, and side to side. These adjustments will be to allow the reel or similar device to be positioned to comb and direct the crop plant into the stripper header thereby increasing the amount of grain or other crop that can be harvested by the stripper header.

Because there are so many manufacturers and models of reels and stripper headers, there are many different variations of how to attach the reel or similar device to the stripper header. The variations include different brackets, cylinders, hoses, valves, levers and different positions of these attaching items on the stripper header. These variations also include using hydraulic, electrical and mechanical means to move and rotate the feeder reel to the desired position in relation to the stripper header. These position adjustments can be performed prior to the start of harvest or performed while harvesting as crop and ground conditions change requiring a new position to maximize the amount of crop that can be harvested.

Having described the invention, here is what is claimed:

1. By attaching the feeder reel (crop conditioner), of any make or model, and positioning the reel in front of a stripper header, of any make or model, a stripper header will be able to harvest crops that are upright, crops with bent over stems and stems that are on the ground. Attaching the feeder reel to a movable framework allows for adjusting the position of the feeder reel up or down and close to or further away from the stripper header. Controls are also necessary to vary the rotational speed of the reel to match the crop and the speed of the harvester. By adjusting the reel, different crops and crop conditions can be addressed to efficiently remove the grain or other type of crop from the stem. The fingers on the feeder reel acting as a crop conditioner pull up and align the stems of the crop for the stripper header to remove the grain or other type of crop.
